(19) United States
(12) Patent Application Publication
(10) Pub. No.: US 2002/0067415 A1
(43) Pub. Date: Jun. 6, 2002

(54) Image sensors with multiple integration/read cycles

(75) Inventors: Peter Brian Denyer, Edinburgh (GB); Jonathan Ephriam David Hurwitz, Edinburgh (GB)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics Ltd, Globe Park (GB)

(21) Appl. No.: 09/891,134

(22) Filed: Jun. 25, 2001

(30) Foreign Application Priority Data
Jun. 28, 2000 (GB) 0015685.1

(51) Int. Cl. H04N 5/335

(52) U.S. Cl. 348/294

(57) ABSTRACT

A method of operating a solid state image sensor having an image sensing array that includes a plurality of active pixels comprises resetting each pixel, and after successive time periods reading outputs from each pixel to obtain multiple sets of image data having different dynamic ranges without resetting the pixels between the successive time periods. The sets of image data are combined to obtain a resultant set of image data having a further dynamic range different from the individual dynamic ranges of the multiple data sets. Images are obtained having low noise, a wide dynamic range, and are resistant to lighting-induced flicker.

### FIELD OF THE INVENTION

The present invention relates to solid state image sensors, and more particularly, to a CMOS-type image sensor in which multiple integration and read cycles are performed between resetting of the sensor pixels. This provides a basis for obtaining images which are low in noise, have a relatively wide dynamic range, and are resistant to flickering induced by power frequency variations of artificial light sources.

### BACKGROUND OF THE INVENTION

Solid state image sensors fabricated using CMOS technology provide a low cost imaging approach, as compared with CCD image sensors, for applications such as digital still cameras, camcorders, web cameras, etc. Many kinds of CMOS imaging circuit architectures are possible, including three main types as illustrated in FIGS. 1(a)-1(b). FIG. 1(a) illustrates a passive pixel type, FIG. 1(b) illustrates a 3-transistor active pixel type, and FIG. 1(c) illustrates a 4-transistor active pixel type.

A disadvantage of the passive pixel type and the 3-transistor active pixel type is with respect to what is what is known as reset noise. This type of noise makes the reset potential of the photodiode forming part of each pixel circuit uncertain. This uncertainty adds to pixel-to-pixel and frame-to-frame variable noise in both still and video images.

The rms magnitude of this reset noise is known to be:

Nᵣₛₜ=√(kT/C) volts

Where k is Boltzmann's constant, T is absolute temperature in Kelvin, and C is the capacitance of the node being reset.

The 4-transistor active pixel type does not suffer from this type of effect if a special type of buried diode is employed which enables the reset node to be entirely depleted of free charge. Photodiode arrays of this type (i.e., pinned photodiode arrays) require at least one manufacturing process step in addition to the normal CMOS process, and incur an overhead cost of at least one additional transistor per pixel as compared to a 3-transistor active pixel.

CMOS image sensors may also suffer a performance disadvantage in environments which are lit by artificial light sources whose intensity varies rapidly in time with the AC power supply frequency, or at some harmonic of this frequency. For example, fluorescent lights flicker at twice the supply frequency. In these conditions the exposure mode of most unshuttered CMOS sensors causes horizontal banding interference in the image, which may also be seen to scroll vertically. To correct this flicker effect, the exposure time is made substantially equal to one period of the flickering source, or an integer multiple thereof.

A third disadvantage, which is common to most image sensors, is that the range of scene luminances that can be captured in one frame (i.e., the dynamic range of the sensor) is significantly limited. In practice, certain noise mechanisms limit the lowest luminance levels, and combinations of supply voltage and circuit design cause areas of the scene which are above a critical luminance to be clipped or saturated. Typically, the dynamic range available in one frame is limited to about 60 dB, but most real scenes contain luminance ranges greater than this.

U.S. Pat. No. 5,926,214 discloses image sensors and methods of operation thereof wherein multiple read cycles are performed between resets of an active pixel sensor array. However, these methods are concerned only with noise reduction and require the use of an optical shutter to mask the array from incident light during an initial reset/read cycle, and during subsequent read operations between successive integration periods.

### SUMMARY OF THE INVENTION

The present invention relates to image sensors having modes of operation in which the operation and timing of certain active pixel sensor arrays substantially eliminates the effects of reset and flicker noise, while also expanding the available instantaneous dynamic range.

The invention may be applied to any active pixel architecture which supports a non-destructive read of pixel values, e.g., the 3-transistor active pixel type but not the passive pixel type. The invention exploits the fact that, with pixel types which support non-destructive read operations, it becomes possible to perform multiple, staggered read operations without the pixels being re-set between read operations, so that the data read at any particular point in time represents the cumulative signal integrated up to that point since the last time the pixels were reset. The invention is particularly intended for use with CMOS type image sensors, image sensor systems and cameras.

In accordance with a first aspect of the invention, a method of operating a solid state image sensor having an image sensing array comprising a plurality of active pixels is provided. The method comprises resetting each pixel, and after a first predetermined period of time reading a first output from each pixel to obtain a first set of image data having a first dynamic range. The method further comprises, without resetting the pixels and after a second predetermined period of time, reading a second output from each pixel to obtain a second set of image data having a second dynamic range. The first and second sets of image data are combined to obtain a resultant set of image data having a further dynamic range different from the first and second dynamic ranges.

The method preferably further comprises, without resetting the pixels and after at least a third predetermined period of time, reading at least a third output from each pixel to obtain a third set of image data having a third dynamic range, and at least the first, second and third sets of image data are combined to obtain a resultant set of image data having a further dynamic range different from the first, second and third dynamic ranges.

In accordance with a second aspect of the invention, a method of operating a solid state image sensor having an image sensing array comprising a plurality of active pixels is provided. The method preferably comprises resetting and immediately reading a preliminary output from each pixel, and after a first predetermined period of time, reading a first output from each pixel. The method preferably further includes the step of determining the difference between the preliminary and first outputs to obtain a set of image data substantially free of noise components represented by the preliminary outputs.

The method in accordance with the first aspect of the invention is preferably combined with the method in accordance with the second aspect of the invention, wherein the preliminary outputs of the second aspect are read immediately after performing the resetting step of the first aspect. Preferably, the method further includes the step of determining the difference between the preliminary outputs and each of the first, second and any subsequent outputs to obtain a plurality of the sets of image data each of which is substantially free of noise components represented by the preliminary outputs.

In each of the aforementioned aspects of the invention, each predetermined time period is preferably selected to be an integer multiple of a predetermined lighting flicker period, and the image sensing array remains continuously exposed to incident light while the method is performed.

In accordance with a further aspect of the invention, there is provided a solid state image sensor adapted to perform a method in accordance with any one of the first to third aspects of the invention. In accordance with another aspect of the invention, there is provided a solid state image sensor system adapted to perform a method in accordance with any one of the first to third aspects of the invention.

In accordance with still another aspect of the invention, there is provided a camera incorporating a solid state image sensor or image sensor system adapted to perform a method in accordance with any one of the first to third aspects of the invention.

### BRIEF DESCRIPTION OF THE DRAWINGS

Embodiments of the invention will now be described, by way of example only, with reference to the accompanying drawings, in which:

FIG. 1(a) illustrates a passive type image sensor pixel in accordance with the prior art;

FIGS. 1(b) and 1(c) illustrate, respectively, a 3-transistor active image sensor pixel and a 4-transistor active image pixel in accordance with the present invention; and

FIG. 2 illustrates in greater detail a portion of a 3-transistor active pixel image sensor array in accordance with the present invention.

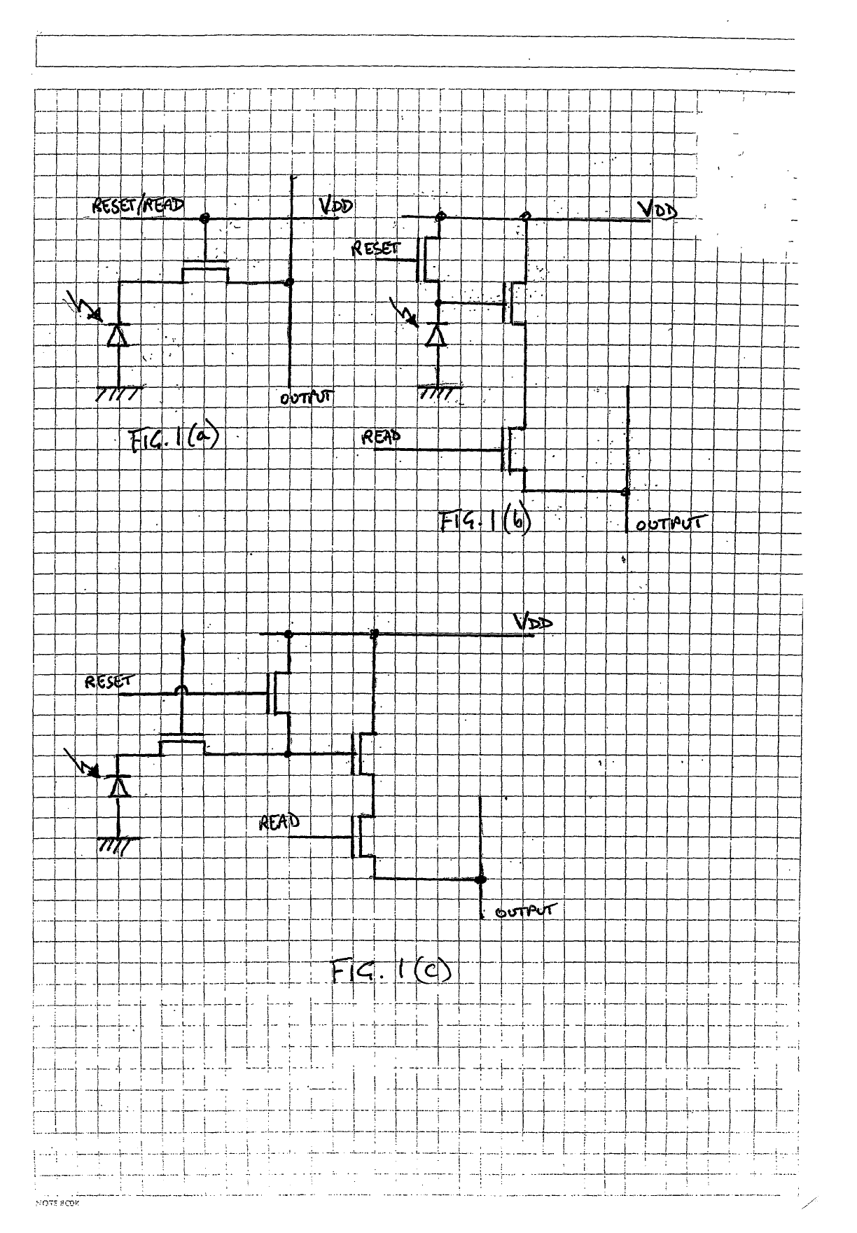

### DETAILED DESCRIPTION OF THE PREFERRED EMBODIMENTS

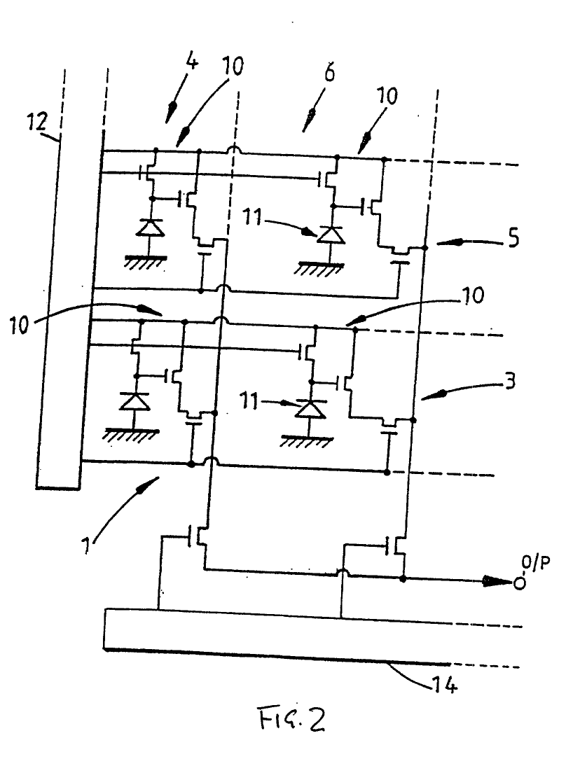

Referring now to FIG. 2 of the drawings, a 2×2 pixel portion of a typical active pixel CMOS image sensor array 1 is shown. The array 1 comprises a plurality of rows 3, 5 . . . and columns 4, 6 . . . of active photosensitive pixels 10 defining an image sensing area. The pixels may be addressed sequentially by vertical 12 and horizontal 14 shift registers electronically connected to the pixels as shown, or by any other suitable pixel addressing scheme such as a decoded address scheme.

The shift registers 12, 14 are electronically connected to scanning circuitry (not shown) for scanning, i.e., reading, the pixel outputs to an output O/P. Any of a variety of known types of active pixels may be used for the pixels of the array. In the array of FIG. 2, the pixels 10 each comprises a photodiode 11 and associated transistor circuitry for use in amplifying (buffering) the diode outputs, and for reading and resetting the diodes 11, as is well known in the art.

In conventional use of a sensor array of this type, the pixels would normally be reset and light would impinge on the photodiodes 11 for a predetermined period (the integration period), before the pixels are read in order to capture a set of image data from the array. The pixels would then be reset prior to each integration period for each image to be captured.

In accordance with the present invention, multiple reads are performed between successive resets. First, the pixels are reset, destroying any previous pixel signals and forcing the photodiode of each pixel to a known reset voltage (Vᵣₜ), and are read immediately after being reset (preliminary read cycle or Read 0). It will be understood that, as in conventional image sensor operation, lines (rows or columns) of pixels are reset and read sequentially, so that all of the pixels in one line are reset simultaneously and then read simultaneously. However, this preliminary read cycle is performed immediately after resetting the pixels, rather than after a predetermined integration period as in conventional image sensors.

The output from each pixel when read immediately after reset is:

Out₀=Vᵣₜ+Nᵣₛₜ+V_{off}+V_{img}

Where Vᵣₜ is the reset voltage, Nᵣₛₜ is the reset noise (different on each reset occasion), V_{off} is a circuit-induced voltage offset whose value can be unique to each pixel due to local random threshold variations, and V_{img} is a signal due to any stray light integration which may have occurred between reset and Read 0, That is, Out₀ comprises a “dark” signal which contains noise comprising the above mentioned components. However, these noise components remain substantially constant over short periods of time and until a new reset occurs.

Following Read 0, and without resetting the pixels, light is integrated during a first predetermined integration period Tᵢₙₜ₁ for producing a signal Sig₁ within each pixel due to the discharge of pixel capacitance by way of photo-induced leakage current. A first read cycle Read 1 is performed at the end of Tᵢₙₜ₁. The output from each pixel when read at the end of Tᵢₙₜ₁ is:

Out₁=Vᵣₜ+Nᵣₛₜ+V_{off}+V_{img}+Sig₁

By calculating the difference between Out₀ and Out₁, the value of Sig₁ can be determined free of the noise components which comprise Out₀, since these components are constant between Read 1 and Read 2, that is:

Out₁−Out₀=Sig₁

The read process described thus far therefore provides an output signal which is substantially free of noise.

Preferably, at least one further read cycle, Read 2, is performed after a second predetermined integration period Tᵢₙₜ₂, again without resetting the pixels. This results in a further discharge of the photodiode capacitance and produces a further signal Sig₂, such that

Out₂−Out₁=Sig₂,

and

Out₂−Out₀=Sig₃

Sig₃=Sig₁+Sig₂, and Sig₂ and Sig₃ are also substantially free of the noise components represented by Out₀.

It can be seen that Sig₁, Sig₂ and Sig₃ provide sets of image data with different exposure periods so that the sensor outputs obtained from the three read cycles provide three different representations of the same scene taken close together in time and having different dynamic ranges. Sig₁, corresponding to the shortest integration period, will contain most information from relatively bright image areas but is likely to be underexposed in relatively dim image areas. Sig₂ will provide an intermediate view, and Sig₃ will contain most information from relatively dim image areas but is likely to be overexposed in relatively bright image areas. The three images may then be combined to obtain a composite image having a dynamic range wider than could be obtained by a single integration period.

The three images may be combined in any of a variety of ways. Generally speaking, the signals will be normalized so that the highest luminance values from the first (shortest exposure) image are scaled to the upper end of a predetermined range of output values. The lowest luminance values from the third (longest exposure) image are scaled to the lower end of the range of output values. Intermediate composite output values are determined by combining and/or scaling intermediate values from all three images.

The pixels may be reset following the final read cycle. It will be understood that the number of read cycles may vary between resets. The method may be implemented using a substantially conventional image sensor, with suitably adapted control software and/or firmware and/or hardware for controlling the timing of reset and read cycles, sufficient frame storage resources to store the multiple sets of data captured in each read cycle, and suitable image processing software and/or firmware and/or hardware for combining the image data as required. Obviously, the greater the number of read cycles the greater the overhead of frame storage and data processing.

It will be understood that the increased dynamic range obtained by multiple integration periods and read cycles may be usefully employed independently of the preliminary read cycle (Read 0) which allows the cancellation of noise from the images. However, it is preferred that these operations are combined to obtain images having low noise and wide dynamic range. All of the images obtained by such multiple read cycles may be free of lighting flicker effects if the integration periods are each selected to be integer multiples of any lighting flicker period.

It will also be understood that the methods and image sensors of the present invention do not require the use of an optical shutter to mask the image sensor either during the initial reset/read operation or during subsequent read operations. Read 0 is performed immediately after reset, with resetting and reading being performed on a sequential, line-by-line basis, and subsequent reads are performed in a similar manner while integration continues.

The methods of the invention may be implemented by a suitably adapted image sensor, or image sensor system, or camera incorporating an image sensor or image sensor system. The methods are also applicable to any type of active pixel architecture, most suitably of the CMOS type, supporting non-destructive read operations. Additional examples of such pixel architectures are illustrated in U.S. Pat. No. 5,926,214 referenced above.

Improvements and modifications may be incorporated without departing from the scope of the invention as defined in the claims appended hereto.

That which is claimed is:

1. A method of operating a solid state image sensor having an image sensing array comprising a plurality of active pixels, the method comprising:
resetting each said pixel;
after a first predetermined period of time reading a first output from each said pixel so as to obtain a first set of image data having a first dynamic range;
without resetting said pixels, after a second predetermined period of time reading a second output from each said pixel so as to obtain a second set of image data having a second dynamic range; and
combining said first and second sets of image data in order to obtain a resultant set of image data having a further dynamic range different from said first and second dynamic ranges.

2. A method as claimed in claim 1, further comprising, without resetting said pixels, after at least a third predetermined period of time reading at least a third output from each said pixel so as to obtain a third set of image data having a third dynamic range; and
combining at least said first, second and third sets of image data in order to obtain a resultant set of image data having a further dynamic range different from said first, second and third dynamic ranges.

3. A method of operating a solid state image sensor having an image sensing array comprising a plurality of active pixels, the method comprising:
resetting and immediately reading a preliminary output from each said pixel;
after a first predetermined period of time, reading a first output from each said pixel.

4. A method as claimed in claim 3, further including the step of determining the difference between said preliminary and first outputs so as to obtain a set of image data substantially free of noise components represented by said preliminary outputs.

5. A method as claimed in claim 1 or claim 2, in combination with a method as claimed in claim 3 or claim 4, wherein said preliminary outputs of claim 3 or claim 4 are read immediately after performing the resetting step of claim 1 or claim 2.

6. A method as claimed in claim 5, further including the step of determining the difference between said preliminary outputs and each of said first, second and any subsequent outputs so as to obtain a plurality of said sets of image data each of which is substantially free of noise components represented by said preliminary outputs.

7. A method as claimed in any preceding claim, wherein the or each said predetermined time period is selected to be an integer multiple of a predetermined lighting flicker period.

8. A method as claimed in any preceding claim, wherein said image sensing array remains continuously exposed to incident light while the method is performed.

9. A solid state image sensor adapted to perform a method as claimed in any one of claims 1 to 8.

10. A solid state image sensor system adapted to perform a method as claimed in any one of claims 1 to 8.

11. A camera incorporating a solid state image sensor or image sensor system adapted to perform a method as claimed in any one of claims 1 to 8.
